(19) United States
(12) Patent Application Publication
(10) Pub. No.: US 2026/0111262 A1
(43) Pub. Date: Apr. 23, 2026

(54) ARTIFICIAL INTELLIGENCE-BASED SYSTEM FOR ARTIFICIAL INTELLIGENCE WORKLOAD AUTOMATION

(71) Applicant: Anil Ravindranath, Sunnyvale, CA (US)

(72) Inventor: Anil Ravindranath, Sunnyvale, CA (US)

(21) Appl. No.: 19/322,183

(22) Filed: Sep. 8, 2025

Related U.S. Application Data
(60) Provisional application No. 63/711,029, filed on Oct. 23, 2024.

(51) Int. Cl. G06F 9/48; G06F 9/455; G06F 9/50

(52) U.S. Cl. CPC G06F 9/4887; G06F 9/45533; G06F 9/5044

(57) ABSTRACT

A system and method are disclosed for automated workload management in artificial intelligence (AI) development. The system includes an observation module for monitoring workloads, a prediction module for recommending compute resources, an optimization module for applying granular real-time adjustments, and an orchestration module for dynamic scheduling and GPU sharing across heterogeneous and multi-cloud environments. By integrating prediction, optimization, and orchestration without user intervention, the system improves utilization, avoids overprovisioning, and accelerates AI model development and deployment.

### CROSS REFERENCE TO RELATED APPLICATIONS

This application claims priority from a U.S. Provisional Patent Appl. No. 63/711,029, filed on Oct. 23, 2024, which is incorporated herein by reference in its entirety.

### FIELD OF INVENTION

The present invention relates generally to compute resource management, artificial intelligence (AI), and workload automation. More particularly, the present invention is directed to an AI-based system and method for automated workload management in connection with AI model development and training.

### BACKGROUND

The process of artificial intelligence (AI) development, including training, tuning, and inference, requires dedicated AI infrastructure consisting of compute, memory, and storage resources. Typically, accelerated compute units, such as graphics processing units (GPUs) and other hardware accelerators, are deployed to execute AI workloads with higher speed and accuracy. However, managing compute resources for AI workloads during the development stage remains a significant challenge. AI workloads are inherently dynamic and unpredictable, making it difficult for data scientists and IT operations teams to allocate the precise infrastructure needed for efficient execution. As a result, substantial amounts of time and compute resources are wasted in manual provisioning, infrastructure tuning, and trial-and-error estimations.

Incorrect allocation of compute resources often leads to errors, delays, and disruptions during AI model training and tuning. Furthermore, for AI models deployed in production (e.g., inference jobs), it is nearly impossible to accurately estimate infrastructure requirements in real time, as workloads fluctuate dynamically depending on variables such as user prompt length, token requests, batch size, input image dimensions, and other task parameters.

To mitigate this uncertainty, organizations commonly resort to worst-case scenario based static allocations of compute infrastructure. This approach results in inefficiency, underutilization, excessive costs, and rigid infrastructure commitments, ultimately hindering AI development and deployment.

Accordingly, there exists a need for systems and methods that can provide precise prediction of compute resource requirements during AI development. There is also a need for automation in the management of dynamic AI workloads to optimize resource utilization, reduce costs, and eliminate guesswork in infrastructure provisioning.

### SUMMARY OF THE INVENTION

The following presents a simplified summary of one or more embodiments of the present invention in order to provide a basic understanding thereof. This summary is not intended to provide an extensive overview of all contemplated embodiments, nor to identify key or critical elements of all embodiments, nor to delineate the scope of the invention. Its purpose is to present certain concepts of one or more embodiments in a simplified form as a prelude to the more detailed description that follows.

The principal object of the present invention is directed to an artificial intelligence-based system and method for automated management of compute resources in AI development environments.

Another object of the present invention is to provide non-intrusive workload analysis that enables management of AI workloads without requiring modifications to existing AI model code or application programming interfaces (APIs).

Another object of the present invention is to provide real-time predictions of compute resource requirements for AI workloads.

Another object of the present invention is to eliminate the need for infrastructure allocation presets, manual estimations, or static configuration of compute resources.

Another object of the present invention is to dynamically handle unpredictable AI workloads by employing continuous learning techniques and iterative resource refinement based on observed workload patterns.

Another object of the present invention is to enable dynamic resource optimization based on real-time workload analysis.

Another object of the present invention is to facilitate automated sharing of compute infrastructure, including accelerator resources such as GPUs, without requiring predefined sharing configurations from users.

Another object of the present invention is to support GPU sharing across multiple jobs without interference between workloads.

Another object of the present invention is to generate automated infrastructure insights from AI model executions to enable future infrastructure planning, resource forecasting, and cost optimization.

The present invention provides numerous technical and operational advantages over conventional approaches to AI workload and infrastructure management. Existing methods typically rely on static infrastructure allocations, manual provisioning, or generalized autoscaling frameworks (such as container-based orchestration systems) that are not specifically optimized for AI workloads. These conventional techniques suffer from inefficiency, overprovisioning, underutilization, and inability to adapt to dynamic and unpredictable AI workloads. By contrast, the present invention leverages intelligent workload analysis, real-time predictions, and continuous learning to achieve the following advantages:

Non-intrusive integration: Unlike traditional resource managers that may require model code changes, instrumentation, or API modifications, the invention manages workload allocation without altering existing AI model code or APIs, ensuring seamless adoption.

Real-time resource prediction: Conventional systems often rely on predefined thresholds or reactive scaling policies. The invention provides proactive, real-time predictions of compute resource needs-including CPUs, memory, storage, and accelerators such as GPUs-eliminating delays and inefficiencies.

Elimination of guesswork: Prior approaches require users to define infrastructure presets, configurations, or conservative estimates. The invention removes this burden by automatically determining appropriate allocations based on workload behavior.

Dynamic workload handling: Unlike static allocations or generic autoscaling, the invention adapts to highly variable and unpredictable AI workloads through continuous learning and iterative refinement of resource allocation.

Resource optimization: While conventional methods frequently result in costly overprovisioning or performance bottlenecks, the invention dynamically optimizes infrastructure utilization, lowering operational costs while maintaining performance.

Intelligent sharing of accelerators: Existing solutions typically enforce rigid partitioning or user-defined sharing rules for GPUs and other accelerators. The invention allows automated, demand-driven sharing of accelerators across multiple jobs without interference, thereby increasing overall utilization.

Enhanced performance reliability: By continuously monitoring workload dynamics and adjusting allocations, the invention avoids the errors, training disruptions, and inference delays that occur under conventional manual or static resource management approaches.

Actionable infrastructure insights: Whereas traditional systems provide limited visibility into workload-resource relationships, the invention generates automated insights and metrics, enabling accurate infrastructure planning, forecasting, and cost optimization.

Improved productivity: By removing the need for data scientists, AI engineers, and IT operations teams to manually configure and tune infrastructure, the invention enables personnel to focus on higher-value tasks such as model architecture design, experimentation, and deployment.

### BRIEF DESCRIPTION OF DRAWINGS

The accompanying drawings, which are incorporated herein and form a part of the specification, illustrate exemplary embodiments of the present invention. The drawings, together with the description, serve to explain the principles of the invention and enable a person skilled in the relevant art to make and use the invention.

FIG. 1 is a block diagram of the system, according to an exemplary embodiment of the present invention.

FIG. 2 is a block diagram showing the architecture of the system, according to an exemplary embodiment of the present invention.

FIG. 3 is a flowchart illustrating the disclosed method for automated workload management in artificial intelligence (AI) development, according to an exemplary embodiment of the present invention.

FIG. 4 is a block diagram showing an overview of the system, according to an exemplary embodiment of the present invention.

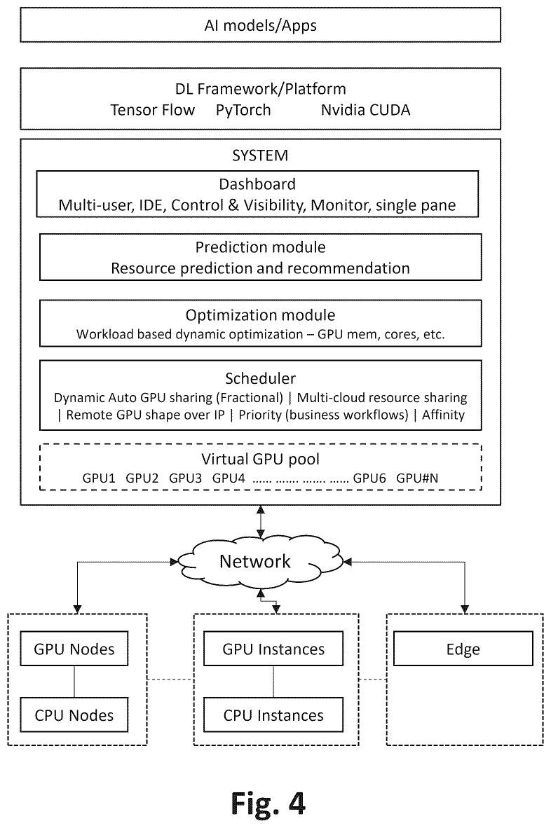

FIG. 5 illustrates the working of the system, according to an exemplary embodiment of the present invention.

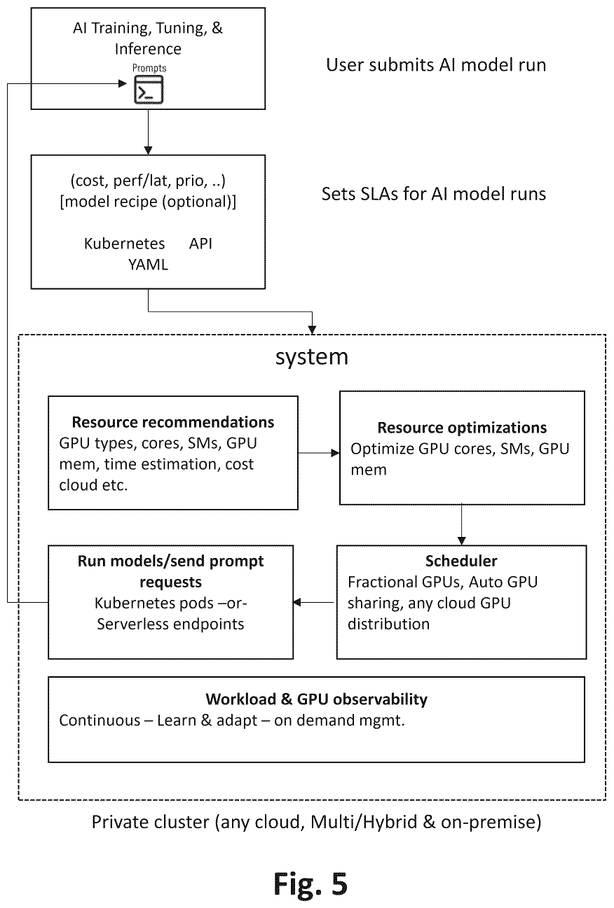

FIG. 6 shows working of the system, according to an exemplary embodiment of the present invention.

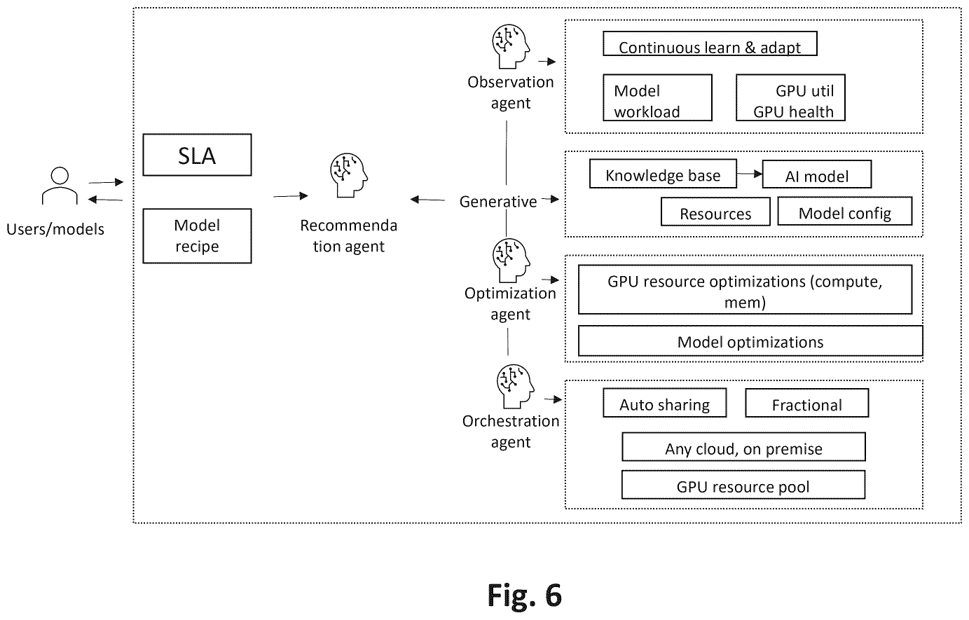

FIG. 7 illustrates a chatbot implemented by a generative tokenizer of the prediction module, according to an exemplary embodiment of the present invention.

FIG. 8 shows the input data analysis, according to an exemplary embodiment of the present invention.

FIG. 9 depicts the equation of sigmoid, according to an exemplary embodiment of the present invention.

FIG. 10 is a diagram to explain the general structure of a decision tree, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The present invention relates to an artificial intelligence-based system and method for automated workload management in AI development. The system provides for AI-driven automation of AI model workloads, covering the processes of observation, prediction, optimization, and orchestration. Advantageously, the disclosed system is capable of continuous learning, thereby improving its effectiveness over time.

In one exemplary embodiment, the disclosed system includes four principal modules: an observation module, a prediction module, an optimization module, and an orchestration module. The observation module performs continuous monitoring of AI workloads and collects workload characteristics, such as compute demand, memory usage, and accelerator utilization. The prediction module applies machine learning techniques to forecast and recommend compute resource requirements for the AI model run in real time. The optimization module adjusts and fine-tunes compute resource allocations in real time to ensure efficient performance. The orchestration module dynamically provisions and manages compute resources across workloads, including CPUs, memory, and GPUs, without requiring manual user intervention. Together, these modules enable the system to predict, optimize, and orchestrate compute resources in real time.

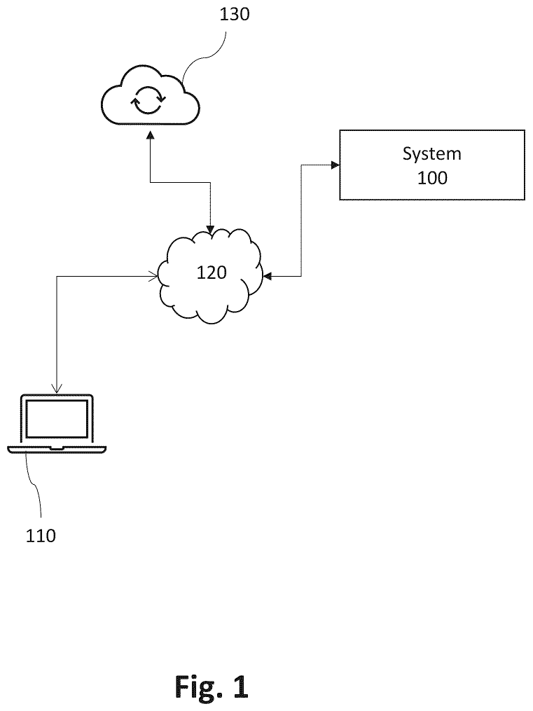

Referring to FIG. 1, a block diagram illustrates an exemplary architecture of the system 100. The system 100 can connect to a user device 110 through a network 120. The user device 110 may be, for example, a smartphone, laptop, desktop, or similar device. The user device includes at least network circuitry for establishing communication with the network, and may further include a display for presenting information and an input interface for receiving user instructions or feedback. The system 100 may also connect to one or more cloud servers 130 via the network 120. Additionally, the system 100 can connect to external databases, third-party APIs, and other remote computing resources as required.

The network 120 may be a wired network, a wireless network, or a combination thereof. Examples include local area networks (LAN), wide area networks (WAN), the Internet, Wi-Fi, WiMAX, cellular networks, or optical fiber networks. While FIG. 1 depicts a single-user device connected through a single network, it will be understood by those skilled in the art that multiple user devices may connect with the disclosed system simultaneously and over different networks. Furthermore, a single user device may connect through a hybrid configuration, such as a combination of Wi-Fi and wired optical communication.

As used herein, the term “user” refers to any person or entity utilizing the disclosed system to manage AI workloads, including but not limited to data scientists, AI engineers, IT operations staff, or automated client applications.

In certain embodiments, the system 100 may be implemented using servers that are co-located in a data center or geographically distributed across multiple sites. The servers may be cloud-based, hybrid, or on-premise deployments. In some configurations, the system may be further integrated with supporting technologies such as distributed ledgers, blockchain frameworks, or public ledger systems to ensure transparency, accountability, and auditability of compute resource allocation and workload orchestration.

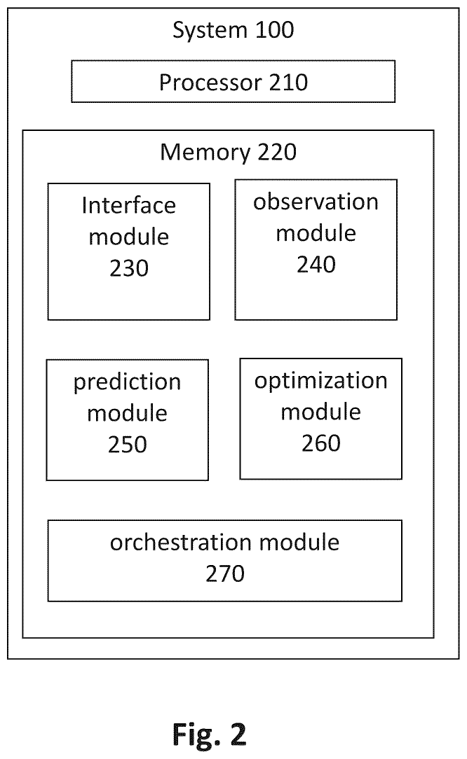

Referring to FIG. 2, a block diagram illustrates the internal architecture of the system 100. The system 100 includes at least one processor 210 and a memory 220. The processor 210 may comprise any form of logic circuitry capable of responding to and processing instructions retrieved from the memory 220. The memory 220 may include one or more memory chips capable of storing data and supporting direct access by the processor. The memory 220 stores executable program code (modules) which, when executed by the processor 210, implement one or more steps of the disclosed methodology. The modules may include software code, algorithms, or program instructions that are executed to carry out workload observation, prediction, optimization, and orchestration

FIG. 2 As shown in FIG. 2, the memory 220 includes an interface module 230, an observation module 240, a prediction module 250, an optimization module 260, and an orchestration module 270. The interface module 230, when executed by the processor, provides a user-facing interface on a user device, enabling bidirectional interaction with the system. Through the interface, workload insights, predictions, and recommendations may be presented, and user input may be received. The observation module 240, when executed by the processor, performs real-time analysis and profiling of AI workloads. It captures workload characteristics and monitors resource utilization. The prediction module 250, when executed by the processor, receives inputs from the observation module 240 and generates recommendations of compute resources using machine learning models. The prediction module applies algorithms such as nearest neighbor, regression, and generative models trained on a knowledge base of prior workloads. The optimization module 260 dynamically refines resource allocations in near real time based on recommendation from the prediction module, ensuring efficiency and cost-effectiveness. The orchestration module 270 provisions and coordinates compute resources for AI workloads, including GPUs, CPUs, and memory, based on outputs from the prediction and optimization modules.

In one embodiment, the observation module 240 may be implemented as a library or lightweight agent that is preloaded when users execute AI models. The agent intercepts calls to GPUs or AI compute resources and extracts model configuration information. AI models generally include configuration parameters (a “recipe”) that describe workload requirements. For example, image classification or object detection models specify image size, filter size, and feature maps, while transformer-based models (e.g., large language models) specify batch size, sequence length, and number of model parameters. These configurations are dynamic and may change during execution.

The observation module 240 captures such configurations in near real time, along with associated GPU utilization data. Parameters monitored may include GPU utilization percentage, number of streaming multiprocessors (SMs) in use, GPU memory consumption, and other compute metrics. This continuous monitoring enables the system to build a workload profile and track changes dynamically as the AI model executes.

The prediction module 250 processes the observation data, received from the observation module, in real time, to predict compute resources required for ongoing and upcoming workload stages. The prediction module is based on a machine learning model trained to predict compute resource requirements, such as memory utilization, number of SMs, or GPU type, using historical workload datasets. Example algorithms include nearest neighbor, regression-based models, and generative models. The prediction module references a training dataset (knowledge base) containing typical model configurations and associated GPU utilization patterns. For example, a training dataset for predicting GPU memory requirements may include entries such as:

dataRapt.csv

batchSize,sequenceLength,parameters,memory
12,1024,7000000000,20
6,512,7000000000,16,
6,512,7000000000,16
6,512,7000000000,16
6,256,7000000000,15
6,256,7000000000,15
6,256,7000000000,15
8,512,7000000000,16
8,512,7000000000,16

Similarly, a dataset for predicting required number of SMs may include:

rapt AI dataset to “num of SMs required” -
batchSize,sequenceLength,parameters,sms
16,512,7000000000,26
16,512,7000000000,26
16,512,7000000000,26
12,1024,7000000000,20
12,1024,7000000000,20
12,1024,7000000000,20
12,512,7000000000,30
12,512,7000000000,30
12,512,7000000000,30

In another embodiment, the training dataset may also include cloud infrastructure details, enabling the system to predict the most cost-efficient GPU and cloud configuration for a given workload. An example dataset is shown below:

Cloud,GPU Type,GPU Arch,GPUs,GPU RAM,vCPUs,RAM,On-demand,Per-GPU,Spot,Name
AWS,A100 (80 GB),Ampere,8,640,96,1152,40.97,5.12,,p4de.24xlarge
AWS,A100 (40 GB),Ampere,8,320,96,1152,32.77,4.10,9.83,p4d.24xlarge
Azure,H100 (80 GB),Ampere,1,80,24,220,3.67,3.67,1.47,NC24ads H100 v4
Azure,A100 (80 GB),Ampere,2,160,48,440,7.35,3.67,2.94,NC48ads A100 v4

Additional training datasets can be prepared for various resource prediction tasks, including memory, compute cores, GPU type, and cost optimization. The prediction module may be trained using such datasets and can invoke them during execution. For example, the prediction module may call a dataset using a function such as:

def predict(batchSize,sequenceLength, parameters):
df = pd.read_csv(‘dataRapt.csv’)

The optimization module 260, when executed by the processor, applies dynamic, fine-grained optimizations of compute resources. These optimizations may include determining the exact allocation of GPU cores, GPU memory, system memory, and other hardware resources. The optimization module 260 operates in conjunction with the prediction module 250, refining its recommendations in near real time. In one embodiment, feedback from the optimization module is supplied back to the prediction module, thereby enabling iterative improvement and adaptive fine-tuning of resource allocation as the workload progresses.

The orchestration module 270, when executed by the processor, applies intelligent scheduling principles to manage compute resources across diverse environments. In one embodiment, the orchestration module facilitates automatic GPU sharing across workloads by dynamically partitioning GPU resources (including fractional GPU sharing). It may further support service-level agreement (SLA)-driven scheduling of AI jobs across multi-cloud environments, on-premise infrastructures, and heterogeneous AI accelerators. The orchestration module 270 can also implement cross-cloud resource pooling, enabling multi-cloud and remote GPU sharing over IP. Additionally, the orchestration module supports workload prioritization, ensuring critical jobs are scheduled with higher priority. In certain embodiments, the orchestration module enables the creation of a virtual GPU pool, which may directly or indirectly connect over a network to multiple GPU nodes, thereby abstracting physical GPU resources into a unified, shareable infrastructure layer.

The interface module 230, when executed by the processor, renders a dashboard on the user device. The dashboard provides a unified development and operations interface with multi-user capability. Through this single-pane interface, users may view, control, and manage different aspects of the system, including workload insights, prediction results, optimization feedback, orchestration decisions, and infrastructure utilization. The dashboard may also function as an integrated development environment (IDE) for configuring AI jobs, monitoring execution, and receiving infrastructure insights.

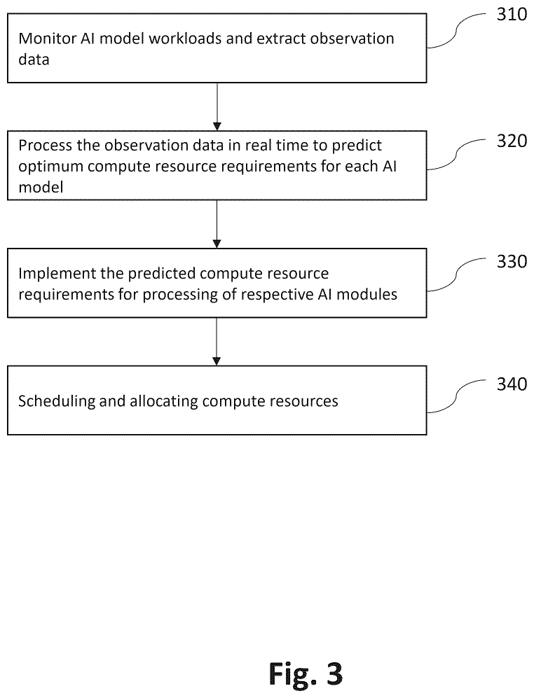

Referring to FIG. 3, a flowchart illustrates an exemplary implementation of the disclosed invention. First, the system receives an AI model workload submitted for execution. The submission may occur during various phases of AI development, including training, tuning, and inference. A user may provide the workload through standard platforms or configuration formats such as YAML, JSON, or Jupyter Notebook.

At step 310, the observation module 240 triggers its workload analysis logic to analyze the submitted AI model. In one embodiment, the observation module intercepts AI model graphs and workload dimensions transmitted to compute resources through calls such as CUDA or ROCm. Based on the intercepted data and configuration file of the AI model, the observation module extracts workload configuration parameters (the “model recipe”), including but not limited to:

For text-based models: batch size, sequence length, context size, maximum tokens generated, number of parameters.

For image-based models: image size, filter size, feature maps, and batch size.

These workload-specific parameters are continuously monitored and updated as the AI model executes.

At step 320, the prediction module 250 dynamically predicts the compute resources required to execute the submitted workload based on the extracted model configuration. For example, if a user runs an AI model with the configuration Batch size=6, Sequence length=512, Number of parameters=7 billion, the prediction module may determine: Type of GPU required, GPU (or compute) memory required, Number of GPU threads required, Number of streaming multiprocessors (SMs) required, Estimated cost to execute the job in a public cloud environment, and Number of distributed workers required to scale the job across multiple GPUs.

In one embodiment, the prediction module first applies a Nearest Neighbor (NN) algorithm to estimate the required compute resources. The module reads workload inputs such as batch size, sequence length, and parameter count, and compares them against a stored dataset of previously analyzed workloads. For example, for an input configuration of Batch size=6, sequence length=512, and parameters=7B, the NN algorithm may search the dataset for the closest matching entries, such as:

(6, 256, 7,000,000,000, 15),
(6, 512, 7,000,000,000, 16),

and select the closest match. In this example, the predicted resource allocation corresponds to 16 GB GPU memory.

In cases where an exact or near-exact match is unavailable, the prediction module may apply a regression-based approach. The regression logic uses statistical techniques such as mean and standard deviation to estimate compute requirements. For example, given an input configuration of Batch size=6, sequence length=485, parameters=7B, and a dataset containing:

(6, 512, 7,000,000,000, 15),
(6, 512, 7,000,000,000, 13),
(6, 512, 7,000,000,000, 16),

the module applies regression to the GPU memory values {15, 13, 16}, yielding an estimated requirement of 14.6 GB memory.

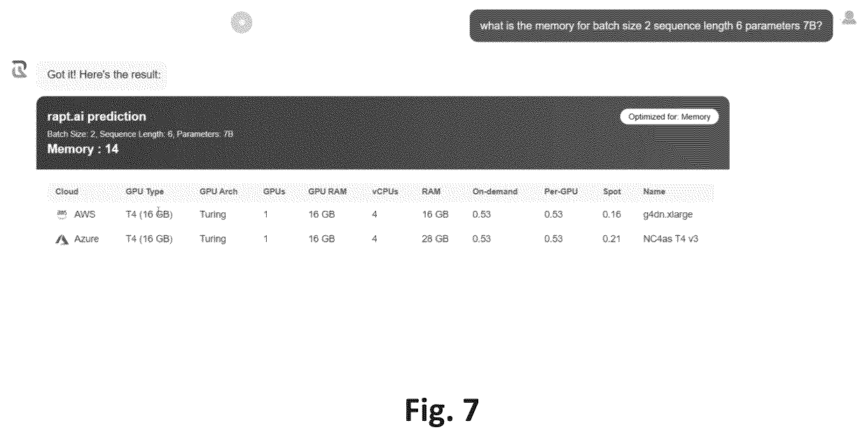

In yet another embodiment, the prediction module can be configured with a generative tokenizer to process natural language prompts. For example, a user may submit the query: “What is the memory required to run an AI model with Batch size=6, sequence length=512, and 7B parameters?” The module applies question-answering techniques using generative tokenizers to infer the result. Similar queries may be processed to estimate cost, number of streaming multiprocessors (SMs), and number of GPUs required for performance scaling. Users may interact with this functionality via APIs, command line interfaces (CLI), user interfaces (UI), or chatbots. FIG. 7 illustrates an example of such an interaction through a chatbot.

At step 330, the optimization module 260 may then apply granular compute resource optimization at the level of GPU SMS, GPU cores, and GPU memory. Unlike conventional systems which optimize only GPU memory, the disclosed module dynamically optimizes multiple dimensions of compute resources. This occurs automatically, without requiring explicit user instructions regarding how many cores or how much memory must be allocated.

For example, a user submits an AI model job. The observation module analyzes the job and the prediction module predicts and recommends the compute resource required. It then passes it to the optimization module. The optimization module applies necessary resource optimization based on what is recommended. In one case, if the recommendation predicted, H100 GPU with 26 SMs and 16 GB memory, the optimization module can allocate exactly 26 SMs and 16 GB memory for the AI model job. If anything changes while the model runs, then again optimization module gets the notification to change the resource allocations based on model needs. All this logic happens automatically and in real time, without any user intervention.

At step 340, the orchestration module 270 implements a multi-layered SLA-driven orchestration mechanism for allocating GPU or compute resources to AI jobs. Similar to the optimization process, orchestration is performed automatically, without requiring user-provided inputs for GPU partitioning or scheduling.

In one embodiment, the orchestration module supports granular GPU sharing, enabling resource allocation at the level of SMs and GPU memory. For instance, when two AI jobs are submitted concurrently, the system may allocate resources on an H100 GPU as follows:
Job 1:26 SMs, 16 GB memory
Job 2:14 SMs, 14 GB memory
   Thus, multiple jobs can share GPU resources dynamically and efficiently.

The orchestration module may also implement automatic job preemption based on priority. For example, if multiple jobs are running concurrently and a user designates one as high-priority via SLA policy, the system may automatically suspend a lower-priority job, migrate its state to system memory, and free GPU resources to execute the high-priority job. Once the high-priority job completes, the lower-priority job is automatically restored from system memory to GPU for execution.

In another embodiment, the orchestration module provides heterogeneous GPU/compute orchestration, allowing AI workloads to run across diverse compute platforms (e.g., NVIDIA, AMD, or other accelerators). The orchestration module automatically schedules jobs across heterogeneous resources according to workload requirements.

The observation module continuously monitors both AI model workloads and compute resource utilization across clusters. Any detected change in workload patterns triggers notification signals to other modules. For example, the prediction module may recompute required resources, the optimization module may reallocate resources, and the orchestration module may migrate or reschedule jobs across nodes.

In one embodiment, the AI model of the predicting module is also referred to herein as resource recommendation engine. This engine implements supervised and statistical learning methods to dynamically predict compute resources required to run an AI model. These predictions include, but are not limited to, (i) selection of suitable GPU hardware for training and inference, (ii) estimation of interference cost when multiple AI jobs are multiplexed on a single accelerator, (iii) nearest-neighbour-based memory and compute estimation from compact workload tables, and (iv) a generative question-answering interface that extracts workload descriptors from natural language prompts. The resource recommendation engine thereby forms the computational core of the prediction module, providing actionable recommendations that are consumed by the optimization module and orchestration module for fine-grained resource allocation and scheduling. Following describes the training of the resource recommendation engine in detail.

Classification of GPU hardware for training:

The GPU classification component is formulated as a supervised learning problem. The engine ingests a labeled dataset in which each record contains workload features and a target label indicating the selected GPU hardware for training.

In one example, the input feature schema (data frame) comprises:
Model_name, Batch_size, Feature_maps, Height, Weight

A corresponding training table augments the features with operational signals (used for analysis, optional model inputs, and/or post-prediction validation):

Model_name, Batch_size, Feature_maps, Height, Width, GPU_utilization,
Performance, num_of_jobs, interference_cost, compute_type, Training_cost,
cloud_type

The output label is encoded in the compute_type column as a binary class:
compute_type: 0→Tesla-V100, 1→Tesla-K80.

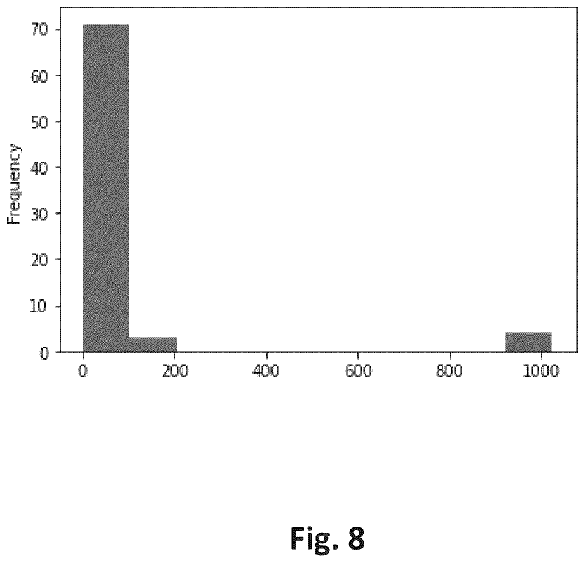

In exemplary embodiments, the classifier is implemented using logistic regression and/or a decision tree (e.g., CART) to classify the GPU hardware. These are supervised algorithms suitable for structured tabular data and binary classification. Feature preprocessing may include scaling of numerical features and optional encoding of Model_name (e.g., one-hot or target encoding). Class imbalance, if present, may be addressed via class weights or resampling. FIG. 8 illustrates the input data analysis and after analysis, training can be performed using the logistic/decision tree algorithms by calling training function.

A representative training procedure is:

```
def rapt_model_train( ):
  # Load latest labeled data
  raptData = pd.read_csv(‘latest_rapt_learning_data.csv’)
  # Split into X (features) and y (compute_type)
  # Perform preprocessing/encoding as needed
  # Train chosen model (logistic regression and/or decision tree)
  model = model.fit(X_train, y_train)
  return model
```

A corresponding inference procedure receives an input tuple—for example (Batch_size, Feature_maps, Height, Width)—and returns the predicted GPU class:

```
def predict_GPU(model, b, f, h, w):
  X_pred = build_feature_vector(b, f, h, w)
  gpu = model.predict(X_pred)
  return gpu # 0−>V100, 1−>K80
```

In one test case with a held-out set, the classifier achieved an accuracy of 0.875. For an input [128, 1024, 28, 28], the predicted hardware was Tesla-V100 (class 0). For an input [128, 1, 28, 28], the predicted hardware was Tesla-K80 (class 1).

### Logistic Regression (Overview)

Logistic Regression is a statistical model used for classification that helps to classify a set of observations into two or more discrete classes. For a single feature x₁, logistic regression computes

$$z = {β}_{0} + {β}_{1} {x}_{1} ,$$

Here, z is output variable/categorical data, x₁ is input data (data frame) collected from the dataset and the coefficients β₀ and β₁ are the parameters of the model.

The above equation extended to multiple features as

$$z = {β}_{0} + {β}_{1} {x}_{1} + {β}_{2} {x}_{2} + … + {β}_{n} {x}_{n} .$$

Above mentioned equation is for multiple features or multiple input dataframes, such as [128, 32, 28, 28] (batch_size, feature_maps, height & width etc.

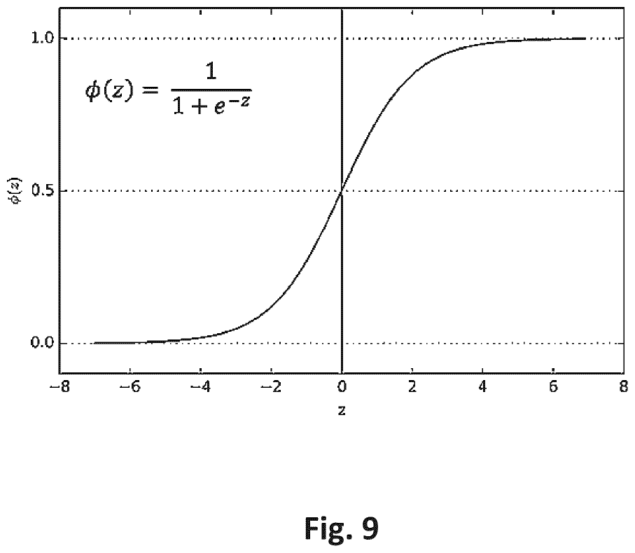

The logistic (sigmoid) function maps z to probability value between 0 and 1. FIG. 9 depicts the equation of sigmoid. This probability value is then mapped to a discrete class which is either “0” or “1 using decision boundary maps and threshold value.

$$\begin{matrix}p \geq 0.5 \text{=>} class = 1 \text{-->} Tesla - k 80 , \\ p < 0.5 \text{=>} class = 0 \text{-->} Tesla - V 100\end{matrix}$$

### Decision Tree (Overview)

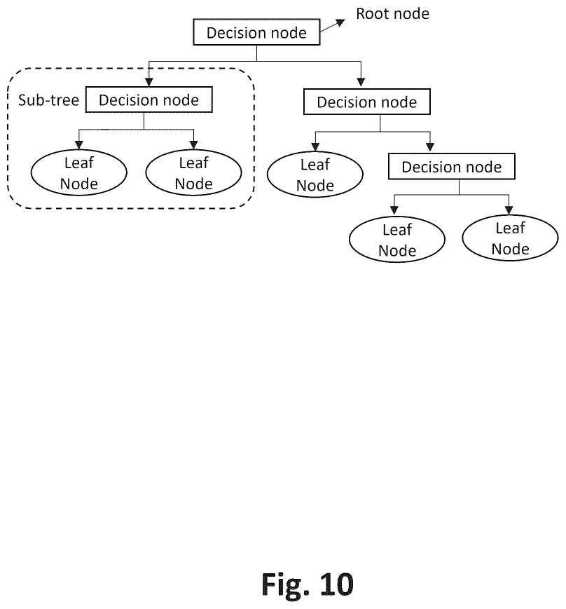

A decision tree recursively partitions the feature space using learned thresholds on input variables (e.g., Batch_size, Feature_maps, Height, Width) until leaves represent class outcomes. Interpretability is advantageous for auditability of resource decisions. FIG. 10 is a diagram to explain the general structure of a decision tree.

### Prediction of Interference Cost

The interference-cost component predicts the performance penalty (or cost proxy) when packing two or more training jobs on a single GPU. The problem is modeled as supervised regression over structured data.

An example input schema mirrors the training table:

(Model_name, Batch_size, Feature_maps, Height, Width, GPU_utilization,
Performance, num_of_jobs, interference_cost, compute_type, Training_cost,
cloud_type)

The target is the continuous variable interference_cost.

In one embodiment, a linear regression model is trained:

```
def rapt_model_train_for_predict_interfc( ):
  raptData = pd.read_csv(‘rapt_learningsystem’, header=None, names=col_names)
  model = LinearRegression( ).fit(X_train, y_train)
  Return Model
```

At inference, given workload features and the requested packing multiplicity number_of_jobs, the model outputs a predicted interference cost:

```
def predict_interf_cost(model, b, f, h, w, number_of_jobs):
  X = build_feature_vector(b, f, h, w, number_of_jobs)
  return model.predict(X)
```

In certain embodiments, regularized regressors (e.g., Ridge/Lasso/Elastic Net) or non-linear models (e.g., Gradient Boosted Trees) may be employed to capture interactions among Batch_size, Feature_maps, num_of_jobs, and hardware label compute_type. Feature importance can be surfaced to the dashboard for explainability.

### Nearest-Neighbour & Generative Q&A Interfaces

In addition to supervised models, the engine supports Nearest Neighbour (NN) estimation over compact performance tables. For instance, given a dataset:

### Batch Size, Seq Len, Parameters, Model, Memory (GB)

16, 128, 8B, bert, 4.0
32, 128, 7B, llama, 6.8
32, 256, 70B, llama, 9.5
64, 128, 7B, mistral, 7.2
64, 256, 8B, llama, 11.0

the NN module computes a distance over (Batch Size, Seq Len) (optionally weighted and normalized) to return the nearest configuration's Memory (GB). If the input is (32, 200, llama), the nearest known configuration (32, 256, llama) yields 9.5 GB. For models with multiple entries (e.g., llama), the system may also compute mean and standard deviation (e.g., 6.8±0.3 for confidence intervals.

The engine further exposes a generative question-answering (Q&A) pathway in which a user poses a natural-language prompt (e.g., “What memory is required for batch size 6, sequence length 512, and 7B parameters?”). A tokenizer/reader (e.g., ROBERTa SQUAD-style pipeline) extracts structured values (batchSize, sequence, parameters) and queries the NN/statistical tables and/or the trained predictors to produce an answer. This interface is available via API, CLI, UI, or chatbot (see FIG. 7).

After extracting numbers from free-text, the system executes Steps 1-3 (table read, association, statistical summary) and then performs NN lookup or model prediction to return estimates for memory, SMs, GPU usage, and related outputs.

### Deployment & Integration

In one embodiment, the resource recommendation engine is packaged as a Python module consumable by third-party applications:

import rapt_resource_recommendation as rrr
model_gpu = rrr.rapt_model_train( )
gpu = rrr.predict_GPU(model_gpu, 128, 1024, 28, 28)
print(“Predicted GPU hardware:”, “V100” if gpu == 0 else “K80”)
model_ic = rrr.rapt_model_train_for_predict_interfc( )
ic = rrr.predict_interf_cost(model_ic, 8, 7, 9, 2, number_of_jobs=2)
print(“Interference cost:”, ic)

The predicted outputs are consumed by the optimization module (to allocate exact SMs/cores/memory) and the orchestration module (to schedule jobs, including fractional GPU sharing and SLA-aware preemption).

### Data Quality & Robustness

To improve robustness, the engine may (a) validate input ranges, (b) track concept drift across time/windows, (c) maintain per-model family calibrations (e.g., CNN vs. Transformer), (d) provide confidence scores (e.g., logistic probability or prediction intervals), and (e) fall back to NN/statistical estimates when classifier confidence is below a threshold.

The system may also maintain a knowledge base that aggregates anonymized telemetry from prior workloads. This knowledge base is periodically distilled into compact lookup tables for NN and into refreshed training corpora for the supervised models, enabling continuous improvement with minimal user intervention.

The disclosed system is particularly advantageous during the AI development phase, where resource requirements are highly variable and difficult to predict. In production deployments, over-provisioning is common, leading to costly underutilization of resources. By contrast, the disclosed system dynamically allocates precise resources, thereby reducing waste and improving efficiency. Accordingly, the system increases productivity for AI engineers and data scientists by automating the otherwise manual and error-prone task of resource planning. It eliminates guesswork and misconfiguration in compute provisioning, improves model execution efficiency, and reduces the time and cost associated with AI workload management.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for automated workload management in artificial intelligence (AI) development, the system comprises a processor and a memory, the memory storing a set of instructions which upon execution by the processor causes:
monitoring continuously, by an observation agent, AI model workloads to extract observation data, the observation data comprises configuration data and compute resources utilization patterns of AI models submitted for execution;
processing, by a machine learning based prediction module, the observation data in real time to predict optimum compute resource requirements for processing each AI model, wherein the prediction module is based on Nearest Neighbor algorithm, Nearest Neighbor with regression, and generative tokenizer;
implementing, by an optimization module, the predicted compute resource requirements for processing of respective AI modules, wherein the optimization module is configured to dynamically optimize granular compute resources including streaming multiprocessors, cores, and memory in real time; and
scheduling and allocating compute resources, by an orchestration module, across heterogeneous and multi-cloud infrastructures, including fractional GPU sharing, job prioritization, and service-level-agreement based orchestration,
wherein the system automatically predicts, optimizes, and orchestrates compute resources for AI models without user intervention.

2. The system of claim 1, wherein the configuration data for text-based models comprises batch size, sequence length, context size, maximum tokens generated, number of parameters.

3. The system of claim 2, wherein the configuration data for image-based models comprises image size, filter size, feature maps, and batch size.

4. The system of claim 1, wherein the nearest neighbor algorithm is to determine compute resource requirements based on prior workload data.

5. The system of claim 4, wherein the regression logic is to estimate compute resource requirements when exact matches are unavailable in the prior workload data.

6. The system of claim 5, wherein the generative tokenizer is for natural language query input.

7. The system of claim 1, wherein the orchestration module is configured to create a virtual GPU pool across multiple compute nodes and enables fractional GPU sharing.

8. The system of claim 1, wherein the orchestration module is configured to preempts lower-priority jobs and reallocates resources to higher-priority jobs based on service-level agreements.

9. A method for automated workload management in artificial intelligence (AI) development, the method implemented within a system comprises a processor and a memory, the method comprises:
monitoring continuously, by an observation agent, AI model workloads and extracting observation data, the observation data comprises configuration data and compute resources utilization patterns of AI models submitted for execution;
processing, by a machine learning based prediction module, the observation data in real time to predict optimum compute resource requirements for processing each AI model, wherein the prediction module is based on Nearest Neighbor algorithm, Nearest Neighbor with regression, and generative tokenizer;
implementing, by an optimization module, the predicted compute resource requirements for processing of respective AI modules, wherein the optimization module is configured to dynamically optimize granular compute resources including streaming multiprocessors, cores, and memory in real time; and
scheduling and allocating compute resources, by an orchestration module, across heterogeneous and multi-cloud infrastructures, including fractional GPU sharing, job prioritization, and service-level-agreement based orchestration,
wherein the system automatically predicts, optimizes, and orchestrates compute resources for AI models without user intervention.

10. The method of claim 9, wherein the configuration data for text-based models comprises batch size, sequence length, context size, maximum tokens generated, number of parameters.

11. The method of claim 10, wherein the configuration data for image-based models comprises image size, filter size, feature maps, and batch size.

12. The method of claim 9, wherein the nearest neighbor algorithm is to determine compute resource requirements based on prior workload data.

13. The method of claim 12, wherein the regression logic is to estimate compute resource requirements when exact matches are unavailable in the prior workload data.

14. The method of claim 13, further comprises:
receiving user queries in natural language form and generating compute resource recommendations via the generative tokenizer.

15. The method of claim 9, further comprising:
creating by the orchestration module a virtual GPU pool across multiple compute nodes and enables fractional GPU sharing.

16. The method of claim 15, further comprising:
preempting, by the orchestration module, lower-priority jobs and reallocates resources to higher-priority jobs based on service-level agreements.

17. A method for automated workload management in artificial intelligence (AI) development, comprising:
observing configuration parameters of an AI model;
predicting compute resource requirements for running the AI model;
optimizing compute resources at a granular level based on the predicted compute resource requirements; and
orchestrating compute resources across heterogeneous and distributed infrastructures,
wherein the observing, predicting, optimizing, and orchestrating are performed automatically without manual user intervention.
